(19) United States
(12) Patent Application Publication
(10) Pub. No.: US 2014/0069387 A1
(43) Pub. Date: Mar. 13, 2014

(54) DUAL FUEL INJECTOR AND COMMON RAIL FUEL SYSTEM USING SAME

(71) Applicants: Cory A. Brown, Peoria, IL (US); Dennis H. Gibson, Chillicothe, IL (US)

(72) Inventors: Cory A. Brown, Peoria, IL (US); Dennis H. Gibson, Chillicothe, IL (US)

(73) Assignee: CATERPILLAR INC., Peoria, IL (US)

(21) Appl. No.: 13/606,484

(22) Filed: Sep. 7, 2012

(51) Int. Cl. F02M 69/50; F02M 43/04

(52) U.S. Cl. 123/456; 239/408

(57) ABSTRACT

In one aspect, a common rail fuel system includes a plurality of fuel injectors that each include an injector body defining a first fuel inlet fluidly connected to a first common rail and a second fuel inlet fluidly connected to a second common rail. Liquid fuel injection from a first nozzle outlet set is facilitated by energizing a first electrical actuator to open a direct operated check. Injection of gaseous fuel from a second nozzle outlet set is facilitated by energizing a second electrical actuator to open an admission valve to flood a gaseous nozzle chamber with high pressure gaseous fuel above a valve opening pressure that opens a conventional spring biased check to facilitate gaseous fuel injection out of second nozzle outlet set.

### TECHNICAL FIELD

The present disclosure relates generally to dual fuel common rail systems, and more particularly to a dual fuel injector.

### BACKGROUND

Fuel injectors with the ability to inject two fuels that differ in at least one of pressure, chemical identity and matter phase are known in the art. For instance, U.S. Pat. No. 7,373,931 teaches a fuel injection system for injecting both liquid diesel fuel and natural gas fuel from a single fuel injector into a compression ignition engine. In this type of system, a relatively small quantity of liquid diesel fuel is injected and compression ignited to in turn ignite a larger charge of natural gas. One strategy in this type of dual fuel system is to utilize common rail structures and strategies for supplying both pressurized liquid diesel and natural gas fuel to the individual fuel injectors. Although dual fuel common rail systems are known in the art, finding a combination of structures and features that render the system commercially viable remains elusive.

The present disclosure is directed toward one or more of the problems set forth above.

### SUMMARY

In one aspect, a fuel injector includes an injector body defining a first fuel inlet, a second fuel inlet, a first nozzle outlet set and a second nozzle outlet set, and has disposed therein a control chamber. A direct operated check is positioned in the injector body and includes a first check valve member with a closing hydraulic surface exposed to fluid pressure in the control chamber. The first check valve member is movable between a closed position in contact with a first seat at which the first fuel inlet is blocked to the first nozzle outlet set, and an open position out of contact with the first seat to fluidly connect the first fuel inlet to the first nozzle outlet set. An admission valve member is positioned in the injector body and movable between a closed position in contact with a second seat to block the second fuel inlet to a nozzle chamber, and an open position out of contact with the second seat to fluidly connect the second fuel inlet to the nozzle chamber. A second check valve member has an opening hydraulic surface exposed to fluid pressure in the nozzle chamber, and is movable between a closed position in contact with a third seat to fluidly block the nozzle chamber to the nozzle outlet set, and an open position out of contact with the third seat to fluidly connect the nozzle chamber to the second nozzle outlet set. A biasing spring is operably positioned to bias the second check valve member toward the closed position.

In another aspect, a common rail fuel system includes a plurality of fuel injectors that each include an injector body that defines a first fuel inlet fluidly connected to a first common rail, and a second fuel inlet fluidly connected to a second common rail. The injector body also defines a first nozzle outlet set and a second nozzle outlet set. Each of the fuel injectors includes a first electrical actuator operably coupled to move a first control valve member between a first position and second position, and a second electrical actuator operably coupled to move a second control valve member between a first position and a second position. Each of the fuel injectors includes a first check valve member fluidly separating the first fuel inlet from the first nozzle outlet set. Each of the fuel injectors includes an admission valve member and a second check valve member separating the second fuel inlet from the second nozzle outlet set.

In still another aspect, a method of operating a common rail fuel system includes injecting liquid fuel from a fuel injector by fluidly connecting a first nozzle outlet set to a first common rail. Gaseous fuel is injected from the fuel injector by fluidly connecting a second nozzle outlet set to a second common rail. The step of injecting liquid fuel includes relieving pressure on a closing hydraulic surface of a first check valve member. The step of injecting gaseous fuel includes moving an admission valve member from a closed position to an open position, and moving a second check valve member from a closed position to an open position.

### BRIEF DESCRIPTION OF THE DRAWINGS

FIG. 1 is a schematic view of a common rail fuel system according to the present disclosure; and

FIG. 2 is a sectioned side diagrammatic view of a fuel injector from the fuel system of FIG. 1.

### DETAILED DESCRIPTION

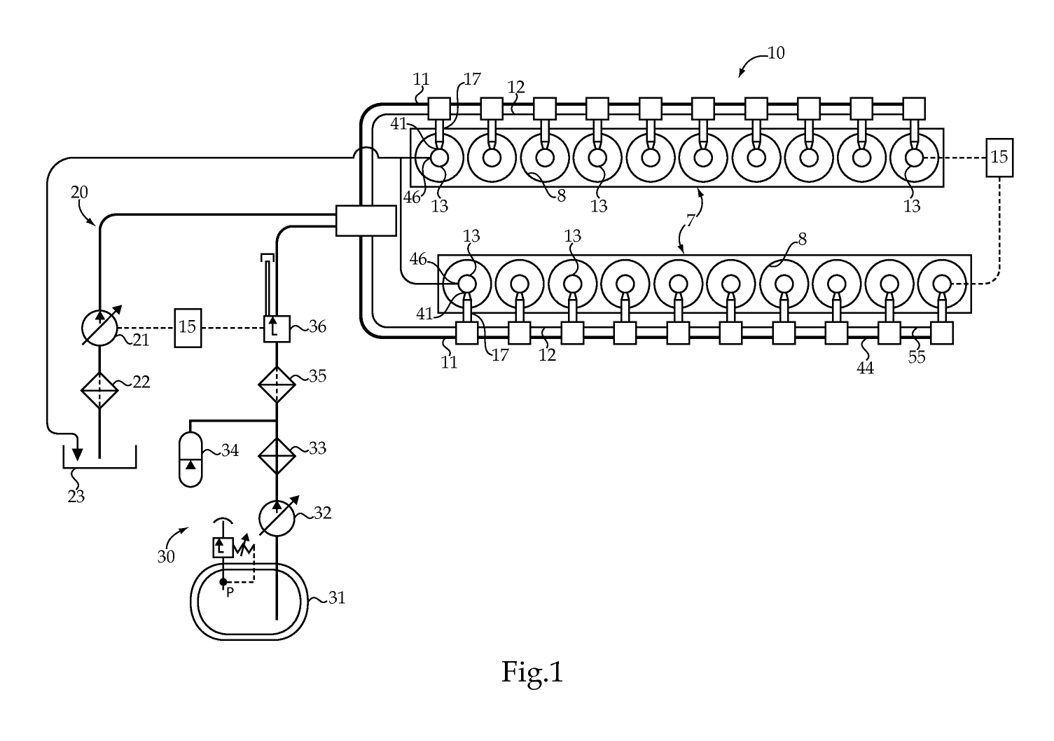

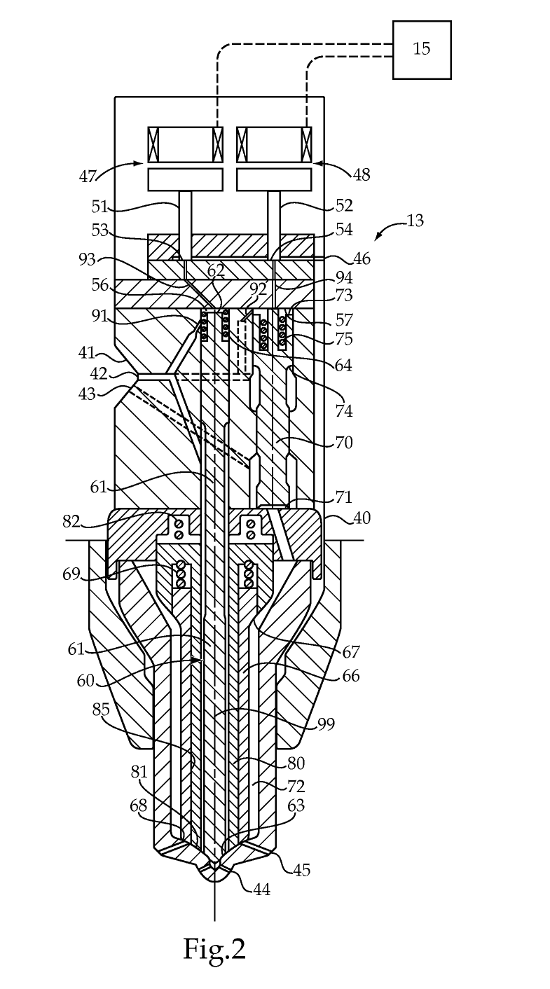

Referring to FIGS. 1 and 2, an engine 7 that includes a plurality of cylinders 8 may be equipped with a common rail fuel system 10. Each of a plurality of fuel injectors 13 are mounted for direct injection into one of the engine cylinders 8. Each of the fuel injectors 13 includes an injector body 40 that defines a first fuel inlet 42 fluidly connected to a first common rail 11, and a second fuel inlet 43 fluidly connected to a second common rail 12. In the illustrated embodiment, the first common rail 11 may contain liquid diesel fuel, and the second common rail 12 may contain pressurized natural gas fuel. Engine 7 may be a compression ignition engine that normally operates by compression igniting a small quantity of liquid diesel fuel to in turn ignite a larger charge of natural gas, with both of the fuels being supplied to the individual cylinder 8 by one fuel injector 13. The injector body 40 also defines a first nozzle outlet set 44 for injecting liquid fuel, and a second nozzle outlet set 45 for injecting gaseous fuel. In the illustrated embodiment, the first and second common rails 11 and 12 may be fluidly connected to the individual fuel injectors 13 via a common conical seat 41. For instance, the individual common rails 11 and 12 may be fluidly connected to the fuel injectors 13 via a co-axial quill assembly 17. However, different fluid connections would also fall within the intended scope of the present disclosure.

Pressurized liquid fuel is supplied to the first common rail 11 by a liquid fuel supply system 20 that includes a high pressure pump 21, a filter 22 and a fuel tank 23. The output of high pressure pump 21 and hence the pressure in first common rail 11 may be controlled by an electronic controller 15 in a conventional manner. The second common rail 12 is supplied by gaseous fuel supply system 30 that may include a cryogenic storage tank 31, a variable displacement pump 32, a heat exchanger 33, an accumulator 34, a filter 35 and a fuel conditioning module 36. Pressure in second common rail 12 may be controlled by electronic controller 15 by way of fuel conditioning module 36. The timing and duration of both liquid and gaseous fuel injection events from fuel injectors 13 might also be controlled by an electronic controller 15 in a conventional manner.

Each of the fuel injectors 13 includes a first electrical actuator 47 coupled to move a first control valve member 51 between a first position in contact with seat 53, and a second position out of contact with seat 53. A second electrical actuator 48 is operably coupled to move a second control valve member 52 between a first position in contact with seat 54 and a second position out of contact with seat 54. Liquid fuel injection events are controlled by energizing and de-energizing first electrical actuator 47, whereas gaseous fuel injection events are controlled by energizing and de-energizing second electrical actuator 48.

The liquid fuel injection side of fuel injector 13 includes a direct operated check 60 that is positioned in injector body 40 and includes a first check valve member 61 with a closing hydraulic surface 62 exposed to fluid pressure in a first control chamber 56. Although not necessary, first control chamber 56 may always be fluidly connected to first fuel inlet 42 and hence first common rail 11 via a Z orifice 91. When first electrical actuator 47 is energized and control valve member 51 is moved out of contact with seat 53, first control chamber 56 becomes fluidly connected to drain outlet 46 via an A orifice 93. When first electrical actuator 47 is de-energized, first control valve member 51 will normally be downward in contact with seat 53 to block a fluid connection between first control chamber 56 and drain outlet 46. First check valve member 61 is normally biased downward by spring 64 into contact with seat 63 to block a fluid connection between first fuel inlet 42 and first nozzle outlet set 44. However, when first electrical actuator 47 is energized to fluidly connect first control chamber 56 to drain outlet 46, pressure in first control chamber 56 will drop allowing first check valve member 61 to lift upwards to provide a direct fluid connection between first fuel inlet 42 and first nozzle outlet set 44. Thus, the first check valve member 61 can be thought of as fluidly separating the first fuel inlet 42 from the first nozzle outlet set 44.

Gaseous fuel injection events may be controlled in a different manner utilizing both an admission valve member 70 and a second check valve member 66. Thus, in the case of gaseous injection events, the admission valve member 70 and the second check valve member 66 may be thought of as separating the second fuel inlet 43 from the second nozzle outlet set 45. In the illustrated embodiment, admission valve member 70 is normally biased downward into contact with a seat 71 by a biasing spring 75. Seat 71 may be a flat seat. Admission valve member 70 is movable between a closed position in contact with seat 71 to block the second fuel inlet 43 to a nozzle chamber 72, and an open position out of contact with seat 71 to fluidly connect the second fuel inlet 43 to nozzle chamber 72. Admission valve member 70 may include a closing hydraulic surface 73 exposed to fluid pressure in a second control chamber 57, which may always be fluidly connected to the high pressure of first fuel inlet 42 via a Z orifice 92. Thus, when second electrical actuator 48 is de-energized and second control valve member 52 is in its downward position in contact with seat 54, second control chamber 57 is blocked from fluid communication with drain outlet 46 allowing high pressure to prevail in second control chamber 57. However, when second electrical actuator 48 is energized to move second control valve member 52 out of contact with seat 54, second control chamber 57 becomes fluidly connect to drain outlet 46 via an A orifice 94, which causes pressure in second control chamber 57 to drop. In the illustrated embodiment, admission valve member 70 includes an opening hydraulic surface 74 that is always exposed to the high pressure originating from first fuel inlet 42. Thus, when pressure drops in second control chamber 57, the pressure force acting on opening hydraulic surface 74 will cause admission valve member 70 to move upward out of contact with seat 71 to provide a direct fluid connection between second fuel inlet 43 and the nozzle chamber 72. When pressure is high in second control chamber 57 acting on closing hydraulic surface 73, a spring 75 biases admission valve member 70 downward toward its closed position in contact with seat 71. Thus, when second control valve member 52 is out of contact with seat 54, second control chamber 57 is fluidly connected to drain outlet 46 via an A orifice 94 to allow pressure to drop in the second control chamber 57.

The second check valve member 66 may be a conventional valve opening pressure operated check valve that includes an opening hydraulic surface 67 exposed to fluid pressure in nozzle chamber 72. A pre-load of biasing spring 69 along with the effective area of opening hydraulic surface 67 may define a valve opening pressure that causes second check valve member 66 to move upward out of contact with seat 68 to fluidly connect nozzle chamber 72 to second nozzle outlet set 45. When pressure in nozzle chamber 72 is below pre-defined valve opening pressure, biasing spring 69 pushes second check valve member 66 downward into contact with seat 68 to fluidly block second nozzle outlet set 45 from nozzle chamber 72. Thus, second check valve member 66 can be thought of as being movable between a closed position in contact with seat 68 to fluidly block nozzle chamber 72 to the second nozzle outlet set 45, and an open position out of contact with seat 68 to fluidly connect nozzle chamber 72 to the second nozzle outlet set 45 to facilitate a gaseous fuel injection event.

Because second to check valve member 66 seats at a seat 68 that is upstream from the nozzle outlet set 45, the present disclosure teaches the inclusion of a sealing member 80 in contact with a seat 81 positioned between the first nozzle outlet set 44 and the second nozzle outlet set 45. This structure helps to inhibit leakage of liquid diesel fuel out of second nozzle outlet set 45 when first check valve member 61 is in its upward position out of contact with seat 63 to facilitate a liquid fuel injection event. Likewise, sealing member 80 being in contact with seat 81 also inhibits migration of gaseous fuel from nozzle chamber 72 toward first check valve member 61. In the illustrated embodiment, sealing member 80 is biased downward into contact with seat 81 by a spring 82 with a sufficient preload that sealing member 80 stays stationary throughout operation of fuel injector 13. Those skilled in the art will appreciate that other strategies could be utilized for holding sealing member 80 stationary in contact with seat 81. Although not necessary, second check valve member 66 may have a guide interaction 85 with sealing member 80 by including an inner diameter with a close guide clearance fit to an outer diameter of sealing member 80. Biasing spring 69, which biases second check valve member 66, may be located in a cavity defined by sealing member 80, or may be located elsewhere without departing from the scope of the present disclosure. In the illustrated embodiment, the first check valve member 61 and the second check valve member 66 share a common concentric centerline 99.

Between injection events, when both first electrical actuator 47 and second electrical actuator 48 are de-energized, first check valve member 61 will be biased downward into contact with seat 63, second check valve member 66 will be biased downward into contact with seat 68, and admission valve member 70 will be biased downward into contact with seat 71. When in this configuration, gaseous fuel will be trapped in the nozzle chamber 72 between second check valve member 66 and admission valve member 70, between gaseous fuel injection events. As stated earlier, the opening hydraulic surface 67 of second check valve member 66 along with the preload of biasing spring 69 define a valve opening pressure, which is preferably greater than pressure of gaseous fuel trapped in nozzle chamber 72 between injection events, but less than a pressure prevailing in the second or gaseous fuel common rail 12.

### INDUSTRIAL APPLICABILITY

The present disclosure finds potential application in any dual fuel common rail system in which the two fuels differ in at least one of pressure, chemical identity and matter phase. In the illustrated embodiment, the two fuels, liquid diesel fuel and pressurized natural gas differ in all three characteristics. The present disclosure finds specific application to use in compression ignition engines seeking to utilize a small quantity of liquid diesel fuel that is compression ignited to in turn ignite a larger charge of natural gas. The present disclosure finds specific application to dual fuel systems in which liquid fuel is injected via operation of a direct operated check 60, whereas the gaseous fuel injection events are controlled with an admission valve member 70 and a conventional valve opening pressure second check valve member 66.

Referring again to FIGS. 1 and 2, common rail fuel system 10 may be operated by injecting liquid fuel from fuel injector 13 by fluidly connecting the first nozzle outlet set 44 to the first common rail 11. Gaseous fuel is injected from fuel injector 13 by fluidly connecting the second nozzle outlet set 45 to the second common rail 12. The step of injecting liquid fuel is accomplished by relieving pressure on a closing hydraulic surface 62 of a first check valve member 61 of direct operated check 60. The specific sequence of events for performing a liquid injection event includes energizing first electrical actuator 47 to fluidly connect first control chamber 56 to drain outlet 46. This causes pressure to drop in first control chamber 56, which in turn allows first check valve member 61 to move upward out of contact with seat 63 to commence the liquid fuel injection through first nozzle outlet set 44. Ending the liquid injection event is accomplished in a reverse order by first de-energizing first electrical actuator 47 to close the fluid connection between first control chamber 56 and drain outlet 46. This causes pressure to rise in first control chamber 56, which may result in a hydraulic balance in first check valve member 61 to permit biasing spring 64 to push first check valve member 61 downward into contact with seat 63 to end the liquid injection event.

The step of injecting gaseous fuel includes moving an admission valve member 70 from a closed position to an open position, and moving the second check valve member 66 from a closed position to an open position. Toward the end of a gaseous fuel injection event, gaseous fuel becomes trapped in fuel injector 13 at a pressure, which is less than a pressure of second common rail 12. The specific sequence of events for a gaseous injection event includes energizing second electrical actuator 48 to fluidly connect second control chamber 57 to drain outlet 46, to relieve pressure on closing hydraulic surface 73. The upward constant force on opening hydraulic surface 74 then causes admission valve member 70 to move upward out of contact with seat 71 to fluidly connect second fuel inlet 43 to nozzle chamber 72. This in turn increases pressure in nozzle chamber 72 above the valve opening pressure associated with second check valve member 66, causing it to move upward against the action of biasing spring 69 out of contact with seat 68 to fluidly connect nozzle chamber 72 to the second nozzle outlet set 45. A gaseous fuel injection event is ended in a reverse manner by first de-energizing second electrical actuator 48 to close the fluid connection between drain outlet 46 and second control chamber 57, resulting in an increase in pressure on closing hydraulic surface 73. Admission valve member 70 may then become hydraulically balanced, allowing biasing spring 75 to push admission valve member 70 downward into contact with seat 71 to block the fluid connection between second fuel inlet 43 and nozzle chamber 72. When this occurs, the gaseous fuel injection event will continue until pressure in nozzle chamber 72 drops below the valve opening pressure associated with second check valve member 66. When this occurs, second check valve member 66 will be moved downward into contact with seat 68 by biasing spring 69 to end the gaseous fuel injection event. However, because the second check valve member 66 closes before nozzle chamber 72 finds equilibrium with the associated engine cylinder 8, pressure in nozzle chamber 72 is trapped until the next gaseous fuel injection event. This trapped pressure will be below the valve opening pressure associated with second check valve member 66 and also below the pressure existing in second common rail 12.

By contacting sealing member 80 with seat 81, fuel injector 13 seals against leakage between the gaseous and liquid fuels, by locating seat 81 between first nozzle outlet set 44 and second nozzle outlet set 45. When second check valve member 66 is moving either toward or away from its closed position, its movement is guided by way of a guide interaction 85 with sealing member 80. As stated earlier, liquid injection is accomplished by relieving pressure on the closing hydraulic surface 62 of first check valve member 61, which is accomplished responsive to energizing first electrical actuator 81. Likewise, movement of admission valve member from its closed position to its open position is facilitated by relieving pressure on closing hydraulic surface 73 responsive to energizing second electrical actuator 48. Regardless of whether a liquid or gaseous fuel injection takes place, by relieving pressure in either first control chamber 56 or second control chamber 57, this action results in draining liquid fuel through the drain outlet 46 of fuel injectors 13, and returning that fuel to tank 23 for recirculation. Thus, in the present disclosure, liquid diesel fuel acts as both an injection medium and as the control fluid in controlling both liquid and gaseous fuel injection events. In the illustrated embodiment, both first check valve member 61 and second check valve member 66 move along a shared concentric centerline 99 to facilitate liquid and gaseous fuel injection events, respectively.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A fuel injector comprising:
an injector body defining a first fuel inlet, a second fuel inlet, a first nozzle outlet set, a second nozzle outlet set, and having disposed therein a control chamber;
a direct operated check positioned in the injector body and including a first check valve member with a closing hydraulic surface exposed to fluid pressure in the control chamber and being movable between a closed position in contact with a first seat at which the first fuel inlet is blocked to the first nozzle outlet set, and an open position out of contact with the first seat to fluidly connect the first fuel inlet to the first nozzle outlet set;
an admission valve member positioned in the injector body and movable between a closed position in contact with a second seat to block the second fuel inlet to a nozzle chamber, and an open position out of contact with the second seat to fluidly connect the second fuel inlet to the nozzle chamber;
a second check valve member with an opening hydraulic surface exposed to fluid pressure in the nozzle chamber, and being movable between a closed position in contact with a third seat to fluidly block the nozzle chamber to the second nozzle outlet set, and an open position out of contact with the third seat to fluidly connect the nozzle chamber to the second nozzle outlet set; and
a biasing spring operably positioned to bias the second check valve member toward the closed position.

2. The fuel injector of claim 1 including a sealing member in contact with a fourth seat that is positioned between the first nozzle outlet set and the second nozzle outlet set.

3. The fuel injector of claim 2 wherein the second check valve member has a guide interaction with the sealing member.

4. The fuel injector of claim 3 wherein the biasing spring is a first biasing spring; and
a second biasing spring operably positioned to bias the sealing member toward a position in contact with the fourth seat.

5. The fuel injector of claim 4 wherein the closing hydraulic surface is a first closing hydraulic surface;
the control chamber is a first control chamber;
the admission valve member includes a second closing hydraulic surface exposed to fluid pressure in a second control chamber; and
a third biasing spring operably positioned to bias the admission valve member toward the closed position.

6. The fuel injector of claim 5 including a first electrical actuator operably coupled to move a first control valve member between a first position at which the first control chamber is blocked to a drain outlet, and a second position at which the first control chamber is fluidly connected to the drain outlet; and
a second electrical actuator operably coupled to move a second control valve member between a first position at which the second control chamber is blocked to the drain outlet, and a second position at which the second control chamber is fluidly connected to the drain outlet.

7. The fuel injector of claim 6 wherein the first control chamber and the second control chamber are fluidly connected to the first fuel inlet.

8. The fuel injector of claim 7 wherein the first check valve member and the second check valve member share common concentric centerline.

9. A common rail fuel system comprising:
a first common rail;
a second common rail;
a plurality of fuel injectors that each include an injector body defining a first fuel inlet fluidly connected to the first common rail, a second fuel inlet fluidly connected to the second common rail, and further defining a first nozzle outlet set and a second nozzle outlet set;
each of the fuel injectors including a first electrical actuator operably coupled to move a first control valve member between a first position and a second position, and a second electrical actuator operably coupled to move a second control valve member between a first position and a second position;
each of the fuel injectors including a first check valve member fluidly separating the first fuel inlet from the first nozzle outlet set;
each of the fuel injectors including an admission valve member and a second check valve member separating the second fuel inlet from the second nozzle outlet set.

10. The common rail fuel system of claim 9 wherein the first common rail contains liquid fuel; and
the second common rail contains gaseous fuel.

11. The common rail fuel system of claim 10 wherein gaseous fuel at a first pressure is trapped between the second check valve member and the admission valve between gaseous fuel injection events;
the second common rail is at a second pressure;
a biasing spring and the second check valve member define a valve opening pressure at which the second check valve member moves from a closed position to an open position; and
the valve opening pressure is greater than the first pressure, but less than the second pressure.

12. The common rail fuel system of claim 11 wherein each of the fuel injectors includes a sealing member in contact with a seat that is positioned between the first nozzle outlet set and the second nozzle outlet set.

13. The common rail fuel system of claim 12 wherein the second check valve member has a guide interaction with the sealing member.

14. A method of operating a common rail fuel system, comprising the steps of:
injecting liquid fuel from a fuel injector by fluidly connecting a first nozzle outlet set to a first common rail;
injecting gaseous fuel from the fuel injector by fluidly connecting a second nozzle outlet set to a second common rail;
the step of injecting liquid fuel includes relieving pressure on a closing hydraulic surface of a first check valve member; and
the step of injecting gaseous fuel includes moving an admission valve member from a closed position to an open position and moving a second check valve member from a closed position to an open position.

15. The method of claim 14 including a step of trapping gaseous fuel in the fuel injector at a pressure, which is less than a pressure of the second common rail, between gaseous injection events by moving the second check valve member to the closed position and the admission valve to the closed position.

16. The method of claim 15 including a step of sealing against leakage between gaseous fuel and liquid fuel in the fuel injector by contacting a sealing member with a seat positioned between the first nozzle outlet set and the second nozzle outlet set.

17. The method of claim 16 including a step of guiding movement of the second check valve member with a guide interaction with the sealing member.

18. The method of claim 17 includes the steps of relieving pressure on a closing hydraulic surface of the first check valve member responsive to energizing a first electrical actuator; and
relieving pressure on a closing hydraulic surface of the admission valve member responsive to energizing a second electrical actuator.

19. The method of claim 18 wherein each of the relieving pressure steps includes draining liquid fuel through a drain outlet of the fuel injector.

20. The method of claim 19 the first check valve member and the second check valve member move along a shared concentric centerline.
